(19) United States
(12) Patent Application Publication
(10) Pub. No.: US 2018/0126498 A1
(43) Pub. Date: May 10, 2018

(54) DEVICE AND METHOD FOR WELDING A FIRST PIPE SEGMENT TO A SECOND PIPE SEGMENT

(71) Applicant: LINDE AKTIENGESELLSCHAFT, München (DE)

(72) Inventors: Georg Wimmer, Tüßling (DE); Eduard Kartmann, Engelsberg (DE); Bernhard Heistinger, Garching / Alz (DE)

(21) Appl. No.: 15/575,833

(22) PCT Filed: May 25, 2016
(86) PCT No.: PCT/EP2016/000868

§ 371 Date: Nov. 21, 2017

(30) Foreign Application Priority Data
May 26, 2015 (EP) 15001585.7

(51) Int. Cl. B23K 37/053; B23K 31/02

(52) U.S. Cl. CPC B23K 37/0531; B23K 2201/06; B23K 31/02

(57) ABSTRACT

The invention relates to a device (1) for welding a first pipe segment (2) to a second pipe segment (3), wherein the device (1) can be inserted into the first and the second pipe segments (2, 3) along a longitudinal axis (L) of the device. Said device (1) has the following: a contact apparatus (6), which has a plurality of contact segments (7, 9), which can be moved radially with respect to the longitudinal axis (L) of the device (1) in order to bring the device in contact with the inside of the first pipe segment (2) and the second pipe segment (3), and a transmission apparatus (26), which is designed to convert an axial movement of the contact segments (7, 9) along the longitudinal axis (L) into the radial movement.

The invention relates to a device and to a method for welding a first pipe segment to a second pipe segment.

In the welding of aluminum pipes for liquefied natural gas or olefin plants, and when a certain proportion of mercury is contained in the product to be conveyed, there is the risk of the mercury accumulating in a gap between a welding support that remains in the aluminum pipes and the aluminum pipes, leading to so-called liquid metal embrittlement (LME) or to electrochemical corrosion. For this reason, further costly measures such as, for example, a mercury separator or tight welding of the welding support in the flow direction of the product to be conveyed, are required.

US 2003/0047650 A1 describes a device for welding two pipe segments. The device comprises plate-shaped contact segments which are disposed between two members that are of a truncated-cone shape. In the converging displacement of the members the latter slide on oblique faces of the contact segments, in order for said members to be displaced radially outward.

U.S. Pat. No. 5,285,947 A describes a device for welding two pipe segments. The device comprises a multiplicity of contact segments which can be moved outward with the help of actuators.

U.S. Pat. No. 3,742,186 A describes a device for welding two pipe segments. The device comprises annular contact segments which are disposed between two members that are of a truncated-cone shape. In the converging displacement of the members the latter slide on oblique faces of the contact segments, in order for said members to be displaced radially outward.

FR 2 801 819 A1 describes a device for welding two pipe segments, having a multiplicity of contact segments which are displaceable radially outward.

WO 2014/191829 A2 describes a device for welding two pipe segments, wherein the device has contact segments which comprise oblique lateral faces. In the axial displacement of the contact segments the latter mutually slide on the oblique lateral faces, on account of which the contact segments are displaced radially outward.

Against this background, the object of the present invention lies in providing an improved device for welding a first pipe segment to a second pipe segment

Accordingly, a device for welding a first pipe segment to a second pipe segment is proposed. The device is introducible along a longitudinal axis of said device into the first and the second pipe segment, wherein the device comprises the following: a contact installation which has a plurality of contact segments which are displaceable radially in relation to the longitudinal axis of the device in order for said contact segments to be brought to bear on the internal side of the first pipe segment and of the second pipe segment, and a gearbox installation which is specified for converting an axial displacement of the contact segments along the longitudinal axis to the radial displacement of said contact segments, wherein the contact installation comprises a first end disk and a second end disk, the contact segments being disposed therebetween.

On account of the axial mutual displacement of the contact segments being convertible to a radial displacement of the latter with the aid of the gearbox installation, it is guaranteed that the contact installation bears on the pipe segments in a planar manner, in particular in the form of a cylindrical face. A welding support that remains in the pipe segments can be dispensed with. On account of the device being removable from the pipe segments again, the former can be reused any number of times. The device is preferably constructed from few individual parts and, on account thereof, can be produced in a rapid and cost-effective manner. Upon welding of the pipe segments, the device is easily releasable and removable from a pipeline that is formed using the pipe segments. In particular, the device is removable from the pipeline without damaging the internal wall of the latter. The pipe segments are preferably made from an aluminum material. Alternatively, the device can also be employed for welding pipe segments from CrNi steel. The contact installation herein can comprise an encircling groove for a root protection gas for welding, and a connector for a supply of the root protection gas for welding. In order for the device to be removed from the pipeline, the device can be moved from a welding position to a drive-in position. In particular in the welding position, all contact segments bear simultaneously on the internal side of the first pipe segment and of the second pipe segment. The device can also be referred to as a welding device or a welding support.

According to an embodiment the contact segments each on the radially external side have a partial surface shell, wherein the partial surface shells collectively define a circular-cylindrical surface shell which is specified for bearing on the internal side of the first pipe segment and of the second pipe segment.

On account thereof, a particularly positive support of the pipe segments during welding is guaranteed. In particular, any slippage of the pipe segments relative to one another can be prevented. The contact segments in the welding position of the device can be flush or be axially mutually offset. The contact segments are preferably annular segments.

According to a further embodiment, the gearbox installation is specified for displacing the contact segments radially outward when the latter are displaced in an axially converging manner.

This results in a simple operating principle. Furthermore, the contact installation can thus be pressed onto the internal side of the pipe segments by way of a defined force.

According to a further embodiment, the gearbox installation is specified for displacing the contact segments radially inward when the latter are displaced in an axially diverging manner.

On account thereof, the device can be removed from the pipe segments in a particularly rapid and simple manner.

According to a further embodiment, the gearbox installation comprises oblique faces that are provided on the contact segments, the contact segments when being axially displaced sliding on said oblique faces.

In particular, each contact segment slides on the oblique faces of two adjacent contact segments.

According to a further embodiment, each contact segment comprises two end segments which each have one oblique face.

In particular, oblique faces of two contact segments that are disposed beside one another are inclined in the same direction. The oblique faces of one contact segment are preferably inclined in a converging manner. The oblique faces of one contact segment can also be inclined in a diverging manner.

According to a further embodiment, each oblique face is inclined relative to an end side of the respective contact segment that points along the longitudinal axis.

The oblique faces preferably run radially in the direction toward the longitudinal axis.

According to a further embodiment, an angle of inclination of each oblique face is 45°.

On account thereof, a particularly simple construction of the contact segments is possible. This reduces the costs for producing the device.

The contact installation comprises a first end disk and a second end disk, the contact segments being disposed therebetween.

The end disks are in particular plate-shaped. Each end disk preferably has a plurality of elongate bores in which screws that are screwed into the contact segments are guided. To this end, each contact segment preferably has a through bore that is provided with an internal thread, two screws being screwed thereinto at both ends. The end disks and/or the screws can be part of the gearbox installation.

According to a further embodiment, the contact segments are connected to the first end disk and to the second end disk in such an alternating manner that a first contact segment in relation to the second end disk is displaceable only radially, and in relation to the first end disk is displaceable radially and axially, and an adjacent second contact segment in relation to the first end disk and to the second end disk is displaceable radially and axially.

With the aid of the screws that are screwed into the contact segments, the end disks are captively connected to the contact segments. Two first and two second contact segments which are disposed in an alternating manner are preferably provided.

According to a further embodiment, the end disks with the aid of a displacement installation are displaceable selectively in a converging or a diverging manner along the longitudinal axis of the contact installation.

The displacement installation can be disposed on one of the end disks or between the end disks.

According to a further embodiment, the displacement installation is operable pneumatically, hydraulically, electromotively, or manually.

For example, the displacement installation can comprise a pneumatic or hydraulic cylinder, an electric motor, or a threaded spindle.

According to a further embodiment, the contact segments are made from a stainless steel material.

For example, the contact segments can be made from austenitic steel, in particular from 1.4301 steel. Alternatively, the contact segments can be made from nickel or a nickel-based alloy.

Furthermore, a method for welding a first pipe segment to a second pipe segment is proposed. The method comprises the following steps: providing a device which is introducible along a longitudinal axis of said device into the first and the second pipe segment, wherein the device comprises a contact installation which has a plurality of contact segments which are displaceable radially in relation to the longitudinal axis of the device in order for said contact segments to be brought to bear on the internal side of the first pipe segment and of the second pipe segment, wherein the contact segments are disposed between a first end disk and a second end disk of the contact installation; placing the device in the first pipe segment and the second pipe segment; axially displacing the contact segments relative to one another, wherein the axial displacement of the contact segments along the longitudinal axis with the aid of a gearbox installation of the device is converted to a radial displacement of the contact segments relative to one another, such that the contact installation bears on the internal side of the first pipe segment and on the second pipe segment; welding the first pipe segment to the second pipe segment; and removing the device from the first pipe segment and from the second pipe segment, wherein, prior to removing the device from the first pipe segment and from the second pipe segment, the contact segments with the aid of an axial displacement of the end disks are displaced radially such that said contact segments are spaced apart from the internal side of the first pipe segment and of the second pipe segment.

The device can be pulled out of the pipe segments that have been welded to form a pipeline with the aid of a steel cable, of a wire, or of a chain, for example. In particular, the device with the latter can also be pulled through a curve of the pipeline.

Prior to removing the device from the first pipe segment and the second pipe segment, the contact segments are displaced radially such that said contact segments are spaced apart from the internal side of the first pipe segment and of the second pipe segment.

On account thereof, the device can be removed from the pipe segments in a particularly simple manner. The radial displacement of the contact segments toward the inside can be performed by an axial displacement of the end disks.

Further possible implementations of the device and/or of the method also include combinations of features or embodiments described above or hereinafter with regard to the exemplary embodiments that have not been described explicitly. A person skilled in the art will also add individual aspects as improvements or supplementations to the respective basic form of the device and/or of the method.

Further advantageous design embodiments and aspects of the device and/or of the method are the subject matter of the dependent claims and of the exemplary embodiments of the device and/or of the method described hereinafter. The device and/or the method will be explained in more detail hereunder by means of preferred embodiments with reference to the appended figures.

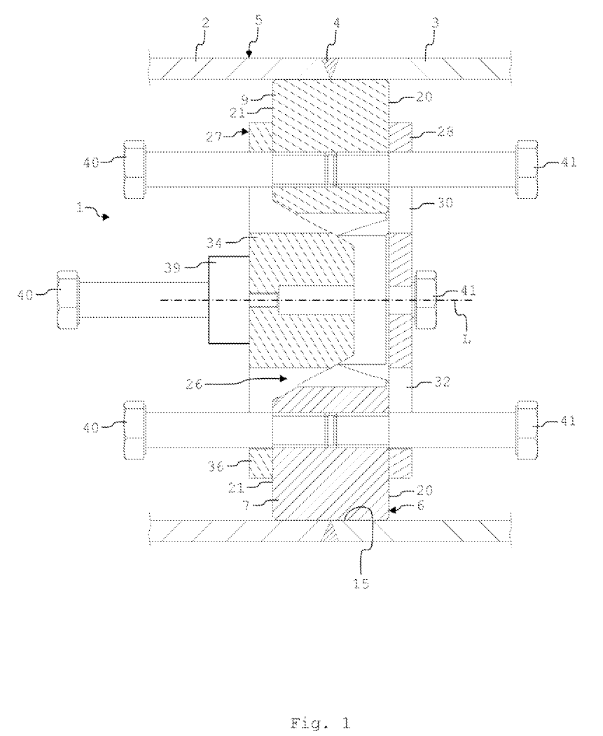

FIG. 1 shows a schematic sectional view of an embodiment of a device for welding a first pipe segment to a second pipe segment;

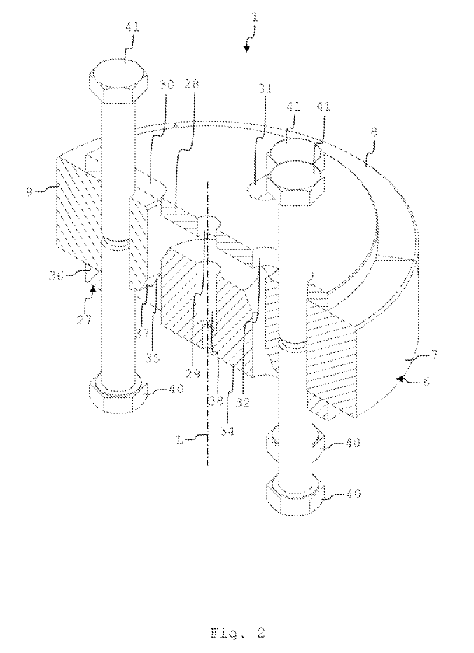

FIG. 2 shows a schematic perspective sectional view of the device according to FIG. 1;

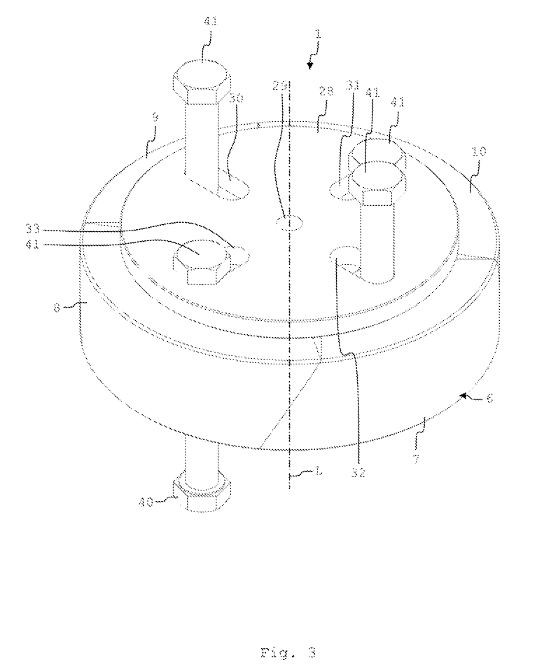

FIG. 3 shows a schematic perspective view of the device according to FIG. 1;

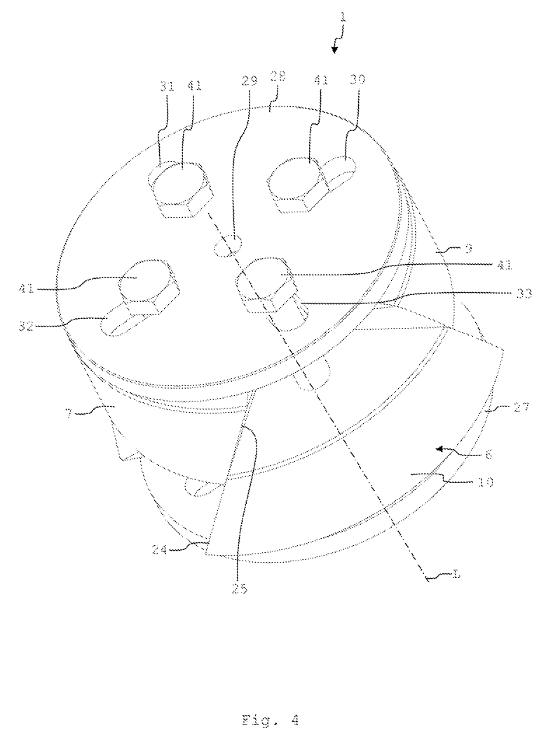

FIG. 4 shows a further schematic perspective view of the device according to FIG. 1;

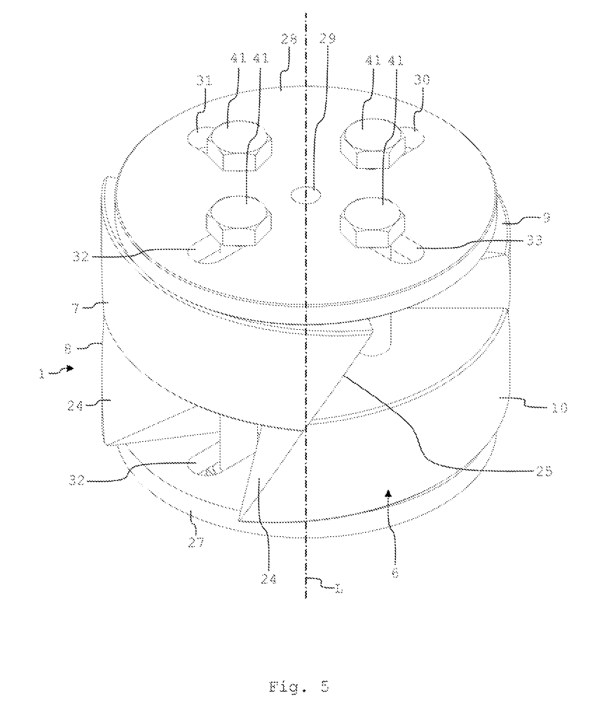

FIG. 5 shows a further schematic perspective view of the device according to FIG. 1;

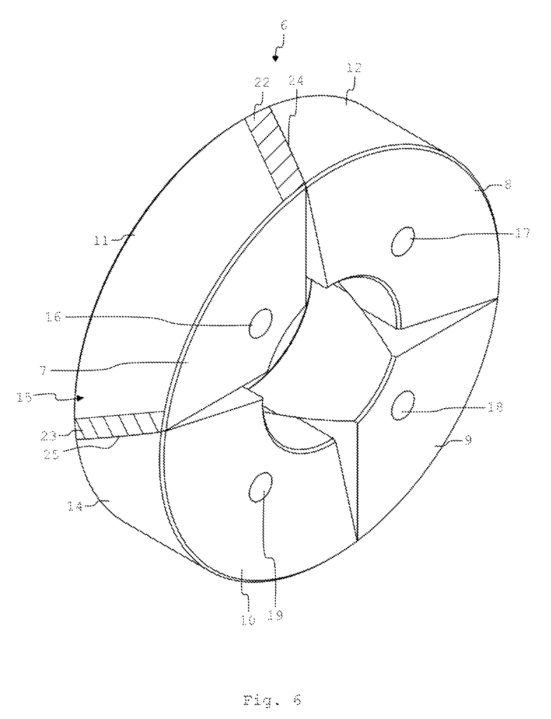

FIG. 6 shows a schematic perspective view of an embodiment of a contact installation for the device according to FIG. 1;

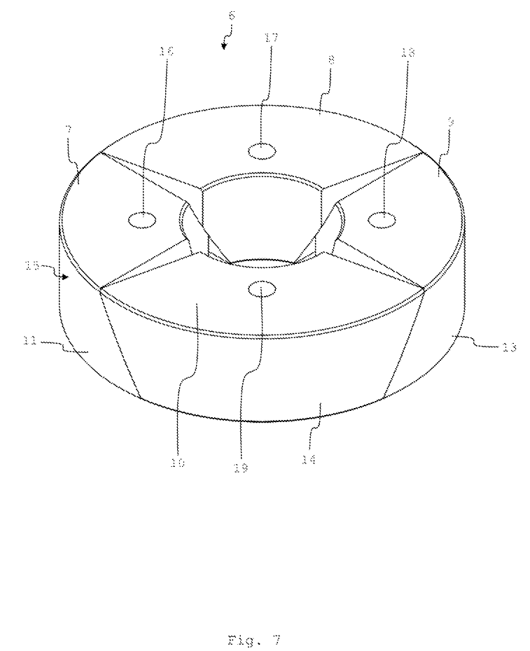

FIG. 7 shows a further schematic perspective view of the contact installation according to FIG. 6;

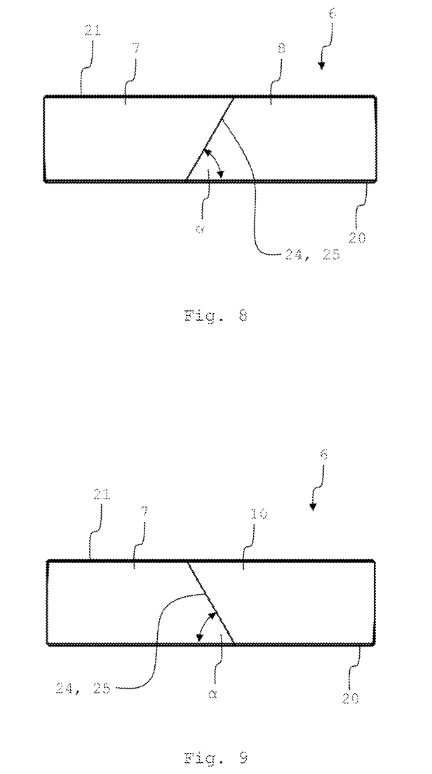

FIG. 8 shows a schematic side view of the contact installation according to FIG. 6;

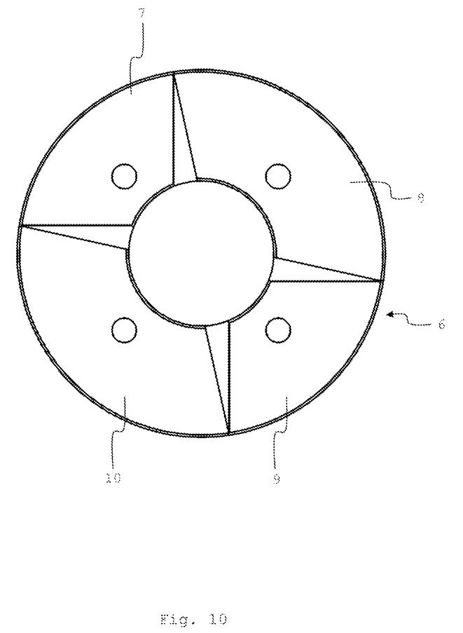

FIG. 9 shows a further schematic side view of the contact installation according to FIG. 6;

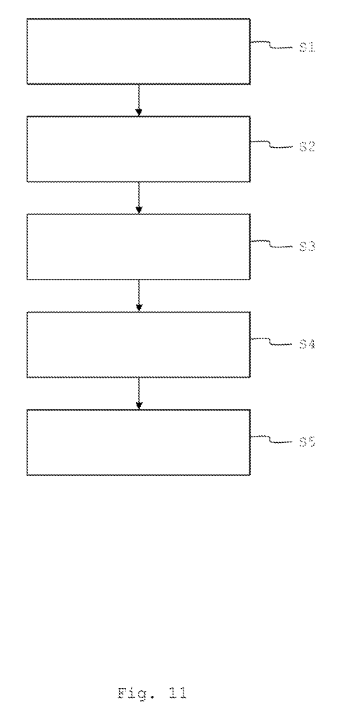

FIG. 10 shows a further schematic view of the contact installation according to FIG. 6; and

FIG. 11 shows a schematic block diagram of an embodiment of a method for welding a first pipe segment to a second pipe segment.

In the figures, elements that are identical or have the same function have been given the same reference signs, unless stated otherwise.

FIGS. 1 and 2 each show a schematic sectional view of a device 1 for welding a first pipe segment 2 to a second pipe segment 3. The device 1 can be referred to as a welding device or a welding support. The pipe segments 2, 3 are butt-welded to one another with the aid of a weld seam 4. The weld seam 4 can be V-shaped. The pipe segments 2, 3 are preferably made from an aluminum material. The mutually welded pipe segments 2, 3 form a pipeline 5, for example for conducting liquefied natural gas (LNG). The device 1 is retrievable from the pipeline 5. This is to say that said device upon welding of the pipe segments 2, 3 does not remain in the pipeline 5.

The device 1 is introducible along a longitudinal axis L of said device 1 into the first pipe segment 2 and the second pipe segment 3. The device 1 comprises a contact installation 6 which comprises a plurality of contact segments 7 to 10. The contact installation 6 has at least three contact segments 7 to 10. As is shown in FIGS. 3 to 5, the contact installation 6 has four contact segments 7 to 10.

The contact installation 6 in each of FIGS. 6 and 7 is shown in a schematic perspective view. FIGS. 8 and 9 each show the contact installation 6 in a schematic side view. FIG. 10 shows the contact installation 6 in a schematic plan view. Reference hereunder is made simultaneously to FIGS. 6 to 10.

The contact installation 6, when viewed along the longitudinal axis L, is annular. Each contact segment 7 to 10 has a partial surface shell 11 to 14 in each case on the radial external side. The partial surface shells 11 to 14 collectively form a circular-cylindrical surface shell 15 of the contact installation 6. Each contact segment 7 to 10 has one through bore 16 to 19. The through bores 16 to 19 each are provided with an internal thread. The contact segments 7 to 10 are made from a stainless steel. For example, the contact segments 7 to 10 can be made from austenitic steel, in particular from 1.4301 steel. Alternatively, the contact segments 7 to 10 can be made from nickel or a nickel-based alloy. As is shown in FIG. 10, the contact segments 8, 10 are larger than the contact segments 7, 9. That is to say that the contact segments 8, 10 in the circumferential direction of the contact installation 6 are larger than the contact segments 7, 9. The contact segments 8, 10 can be referred to as first contact segments 8, 10, and the contact segments 7, 9 can be referred to as second contact segments 7, 9.

In each case pointing along the longitudinal axis L, the contact segments 7 to 10 each have one front side or first end side 20, and one rear side or second end side 21. Each contact segment 7 to 10 in the circumferential direction has one first end segment 22 and one second end segment 23. Each end segment 22, 23 has respectively one oblique face 24, 25. The oblique faces 24, 25 are inclined in a converging or diverging manner, respectively. Oblique faces 24, 25 of adjacent contact segments 7 to 10 are in each case inclined in the same manner. The oblique faces 24, 25 run radially toward the longitudinal axis L. As is shown in FIGS. 8 and 9, the oblique faces 24, 25 are inclined relative to the first end side 20 of the respective contact segment 7 to 10. An angle of inclination a can be 45°, for example.

Returning now to FIGS. 1 to 5, the contact segments 7 to 10 are displaceable radially in relation to the longitudinal axis L in order for the contact installation 6 to be brought to bear on the internal side of the first pipe segment 2 and of the second pipe segment 3. To this end, the device 1 comprises a gearbox installation 26 which is specified for converting an axial displacement of the contact segments 7 to 10 along the longitudinal axis L to the radial displacement of said contact segments 7 to 10. With the aid of the gearbox installation 26, the contact segments 7 to 10 are displaced radially outward when the latter are displaced in an axially converging manner, such that the circular-cylindrical surface shell 15 bears in a planar manner on the internal side of the first pipe segment 2 and of the second pipe segment 3. In particular, the cylindrical surface shell 15 bears in a fully planar manner on the first pipe segment 2 and on the second pipe segment 3.

The gearbox installation 26 is specified for displacing the contact segments 7-10 radially outward when the latter are displaced in an axially converging manner. As opposed thereto, the gearbox installation 26 is also specified for displacing the contact segments 7 to 10 radially inward when the latter are displaced in an axially diverging manner. On account thereof, the device 1 upon welding of the pipe segments 2, 3 can be removed from the pipe segments 2, 3.

The gearbox installation 26 comprises the oblique faces 24, 25 that are provided on the contact segments 7 to 10, the contact segments 7 to 10 when being axially displaced sliding on said oblique faces 24, 25. The contact installation 6, and in particular the gearbox unit 26, furthermore comprise a first end disk 27 and a second end disk 28 that is disposed so as to be spaced apart from the first end disk 27. The contact segments 7 to 10 are disposed between the end disks 27, 28. The second end disk 28 is plate-shaped and has a centric cut-out or a centric bore 29. The second end disk 28 furthermore comprises four elongate bores 30 to 33 which are mutually disposed at an angle of 90°.

In a manner analogous to that of the second end disk 28, the first end disk 27 likewise has elongate bores 30 to 33. The first end disk 27 furthermore comprises a base segment 34 which is disposed so as to be centric and rotationally symmetrical to the longitudinal axis L. The base segment 34 by way of an encircling incline 35 transitions to a disk-shaped contact segment 36 of the first end disk 27. A respective incline 37 of the contact segments 7 to 10 bears on the incline 35. The base segment 34 has a central receptacle segment 38 which comprises a dual-stage diameter.

The device 1 can furthermore have a displacement installation 39 shown in FIG. 1. The displacement installation 39 can comprise an actuator. The displacement installation 39 is specified for displacing the end disks 27, 28 in a converging or diverging manner. The displacement installation 39 can be operable pneumatically, hydraulically, electromotively, or manually. The actuator such as, for example, a pneumatic or hydraulic cylinder, for example, or another part of the displacement installation 39, can be disposed in the receptacle segment 38.

The device 1 furthermore comprises eight screws 40, 41, two screws 40, 41 being assigned to each contact segment 7 to 10. The screws 40, 41 are routed through the elongate bores 30 to 33 of the end disks 27, 28. The screws 40, 41 are screwed into the through bores 16 and 18 of the respective contact segments 7 and 9 in such a manner that the screws 40, 41 meet in a centric manner in the through bores 16 and 18. On account thereof, the end disks 27, 28 are displaceable axially in relation to the contact segments 7, 9. The contact segments 8, 10 are likewise provided with screws 40, 41 in each case which are screwed into the through bores 17, 19. The screws 41 herein are so short that the contact segments 8, 10 are not displaceable axially in relation to the second end disk 28. However, a radial displacement along the elongate bores 31, 32 is indeed possible.

The functioning mode of the device 1 will be explained hereunder. FIGS. 1, 2, and 3 show the device 1 in a position, in particular in a welding position, in which the end disks 27, 28 are converged such that the contact segments 7 to 10 in relation to the longitudinal direction L are displaced radially outward to the maximum, so as to bear on the internal side of the pipe segments 2, 3. The end disks 27, 28 in particular in this position can bear on the contact segments 7 to 10 on both sides. The contact segments 7 to 10 in the welding position are not axially mutually offset. However, depending on an internal diameter of the pipe segments 2, 3, the contact segments 7 to 10 in the welding position can also be mutually offset. That is to say that it is not a mandatory requirement for the contact segments 7 to 10 in the welding position to be disposed so as not to be axially offset.

With the aid of the gearbox installation 26 which comprises the oblique faces 24, 25, the contact segments 7 to 10 are displaced radially outward when the end disks 27, 28 are displaced in a converging manner, such that said contact segments 7 to 10 come into contact with the pipe segments 2, 3. The contact segments 8, 10 herein, with the aid of the screws 41, are fastened to the end disk 28 such that the contact segments 8, 10 can be displaced only radially but not axially in relation to the second end disk 28. The first end disk 27 is displaceable axially in relation to the contact segments 8, 10. The contact segments 7, 9 are displaceable axially in relation to both end disks 27, 28.

FIGS. 4 and 5 show the device 1 in a position, in particular in a drive-in position, in which the end disks 27, 28 are displaced in a diverging manner. The contact segments 7 to 10 are likewise displaced axially in relation to the longitudinal direction L when the end disks 27, 28 are displaced in a diverging manner, wherein the oblique faces 24, 25 of the contact segments 7 to 10 slide on one another in order for the contact segments 7 to 10 to be displaced radially inward. The device 1 in the drive-in position is removable from the pipeline 5. To this end, a cable, a wire, a chain, or the like, can be fastened to the device 1.

FIG. 11 in a schematic block diagram shows a method for welding the first pipe segment 2 to the second pipe segment 3. The method has a step S1 of providing the device 1 which is introducible along the longitudinal axis L of said device 1 into the first and the second pipe segment 2, 3, wherein the device 1 comprises the contact installation 6 which has a plurality of contact segments 7 to 10 which are displaceable radially in relation to the longitudinal axis L of the device 1 in order for said contact segments 7 to 10 to be brought to bear on the internal side of the first pipe segment 2 and of the second pipe segment 3. In a step S2 the device 1 is placed in the first pipe segment 2 and the second pipe segment 3. In particular, the device 1 can initially be placed only in the first pipe segment 2 or only in the second pipe segment 3.

In a step S3 the contact segments 7 to 10 are displaced axially relative to one another by means of displacing the end disks 27, 28 in a diverging manner by activating the displacement installation 39, wherein the axial displacement of the contact segments 7 to 10 along the longitudinal axis L with the aid of a gearbox installation 26 of the device 1 is converted to a radial displacement of the contact segments 7 to 10 relative to one another, such that the contact installation 6 bears on the internal side of the first pipe segment 2 and of the second pipe segment 3. In particular, the device 1 can initially be placed only in the first pipe segment 2, and the contact segments 7 to 10 can be displaced radially outward so far until the contact installation 6 bears on the first pipe segment 2. The second pipe segment 3 then can furthermore be pushed onto the device 1. The contact segments 7 to 10 can subsequently be displaced farther radially outward such that the device 1 bears tightly on the internal side of both pipe segments 2, 3.

In a step S4 the first pipe segment 2 is welded to the second pipe segment 3. The pipe segments 2, 3 are butt-welded, in particular. The connecting weld seam 4 can be V-shaped. The pipe segments 2, 3 can be welded by means of an automatic welding method. In a final step S5 the device 1 is removed from the first pipe segment 2 and the second pipe segment 3. In order for the device 1 to be removed from the first pipe segment 2 and from the second pipe segment 3, the end disks 27, 28 with the aid of the displacement installation 39 are displaced axially in relation to one another, in particular displaced in a diverging manner. The device 1 can then be pulled out of the pipe segments 2, 3.

On account of the device 1 being removable from the pipe segments 2, 3 again, the former can be reused any number of times. The device 1 is constructed from few individual parts and, on account thereof, can be produced in a rapid and cost-effective manner. The device 1 upon welding of the pipe segments 2, 3 is easily releasable and removable from the pipeline 5. In particular, the device 1 is removable from the pipeline 5 without damaging the internal wall of the latter. On account of the device 1 being removable from the pipeline 5, a welding support which remains in the pipeline 5 and on which mercury could accumulate can be dispensed with.

Although the present invention has been described using working examples, it is modifiable in diverse ways.

In principle, the device 1 can also be employed for welding pipe segments 2,3 from CrNi steel. To this end, the contact installation 6 can be provided an encircling groove for a root protection gas for welding, and a connector for a supply of the root protection gas for welding.

### REFERENCE SYMBOLS USED

1 Device
2 Pipe segment
3 Pipe segment
4 Weld seam
5 Pipeline
6 Contact installation
7 Contact segment
8 Contact segment
9 Contact segment
10 Contact segment
11 Partial surface shell
12 Partial surface shell
13 Partial surface shell
14 Partial surface shell
15 Surface shell
16 Through bore
17 Through bore
18 Through bore
19 Through bore
20 End side
21 End side
22 End segment
23 End segment
24 Oblique face
25 Oblique face
26 Gearbox installation
27 End disk
28 End disk
29 Bore
30 Elongate bore
31 Elongate bore
32 Elongate bore
33 Elongate bore
34 Base segment
35 Incline
36 Contact segment
37 Incline
38 Receptacle segment
39 Displacement installation
40 Screw
41 Screw
L Longitudinal axis α Angle of inclination

1. A device for welding a first pipe segment to a second pipe segment, wherein the device is introducible along a longitudinal axis of the device into the first pipe segment and the second pipe segment, the device further comprising:
a contact installation having a plurality of contact segments which are displaceable radially in relation to the longitudinal axis of the device (1) such that the contact segments are brought to bear on the internal side of both the first pipe segment and the second pipe segment, and
a gearbox installation arranged to convert an axial displacement of the contact segments along the longitudinal axis to the radial displacement of the contact segments, wherein the contact installation comprises a first end disk and a second end disk and the contact segments are disposed between the first end disk and the second end disk.

2. The device according to claim 1, wherein the contact segments on the radially external side have a partial surface shell, and wherein partial surface shells collectively define a circular-cylindrical surface shell which is specified for bearing on the internal side of the first pipe segment demand of the second pipe segment.

3. The device according to claim 1, wherein the gearbox installation is arranged to displace the contact segments radially outward when the contact segments are displaced in an axially converging manner.

4. The device according to claim 1, wherein the gearbox installation is arranged to displace the contact segments radially inward when the contact segments are displaced in an axially diverging manner.

5. The device according to claim 1, wherein the gearbox installation further comprises oblique faces provided on the contact segments, wherein the contact segments are arranged to slide in an axially displaced direction on the oblique faces.

6. The device according to claim 5, wherein each contact segment further comprises two end segments each having one oblique face.

7. The device according to claim 5, wherein each oblique face is inclined relative to an end side of the respective contact segment that points along the longitudinal axis.

8. The device according to claim 7, wherein each oblique face is arranged at an angle of inclination of 45°.

9. The device according to claim 1, wherein the contact segments are connected to the first end disk and to the second end disk in an alternating manner such that a first contact segment in relation to the second end disk is displaceable radially, and in relation to the first end disk is displaceable radially and axially, and an adjacent second contact segment in relation to the first end disk to the second end disk is displaceable radially and axially.

10. The device according to claim 1, wherein the end disks with the aid of a displacement installation are displaceable selectively in a converging or a diverging manner along the longitudinal axis of the contact installation.

11. The device according to claim 10, wherein the displacement installation is operable pneumatically, hydraulically, electromotively, or manually.

12. The device according to claim 1, wherein the contact segments comprise stainless steel.

13. A method for welding a first pipe segment to a second pipe segment, the method comprising the following steps of:
providing device which is introducible along a longitudinal axis of the device into the first pipe segment and the second pipe segment, the device comprising a contact installation which has a plurality of contact segments which are displaceable radially in relation to the longitudinal axis in order for the contact segments to be brought to bear on an internal side of the first pipe segment and of the second pipe segment and wherein the contact segments are disposed between a first end disk and a second end disk of the contact installation;
placing the device in the first pipe segment and in the second pipe segment;
axially displacing the contact segments relative to one another, wherein the axial displacement of the contact segments along the longitudinal axis with the aid of a gearbox installation of the device is converted to a radial displacement of the contact segments relative to one another, such that the contact installation bears on the internal side of the first pipe segment and on the second pipe segment;
welding the first pipe segment to the second pipe segment; and
removing the device from the first pipe segment and from the second pipe segment, wherein, prior to removing the device from the first pipe segment and from the second pipe segment, the contact segments with the aid of an axial displacement of the end disks are displaced radially such that the contact segments are spaced apart from the internal side of the first pipe segment and the second pipe segment.
